(19) United States
(12) Patent Application Publication
(10) Pub. No.: US 2011/0058962 A1
(43) Pub. Date: Mar. 10, 2011

(54) COMPRESSOR FOR USE IN A VEHICLE

(75) Inventors: Nobuaki HOSHINO, Aichi-ken (JP); Masahiro Kawaguchi, Aichi-ken (JP); Masaki Ota, Aichi-ken (JP); Yoshio Kimoto, Aichi-ken (JP); Toru Onishi, Aichi-ken (JP)

(73) Assignee: KABUSHIKI KAISHA TOYOTA JIDOSHOKKI, Kariya-shi (JP)

(21) Appl. No.: 12/872,199

(22) Filed: Aug. 31, 2010

(30) Foreign Application Priority Data
Sep. 4, 2009 (JP) P2009-204281

(51) Int. Cl. B60H 1/32; F04B 23/10

(52) U.S. Cl. 417/206; 417/231

(57) ABSTRACT

A compressor for use in a vehicle includes a mechanical compression mechanism including a first casing and a drive shaft. The first casing has therein a first suction chamber and a first discharge chamber. The drive shaft is rotatably supported by the first casing and mechanically driven by a drive source for compression of refrigerant. The compressor further includes a linear electric compression mechanism including a second casing and a piston. The second casing has therein a second suction chamber and a second discharge chamber. The piston is reciprocally movable in the second casing and driven by electromagnetic force for compression of refrigerant. The first casing is integrated with the second casing so as to allow at least one of fluid communication between the first suction chamber and the second suction chamber and between the first discharge chamber and the second discharge chamber.

### BACKGROUND OF THE INVENTION

The present invention relates to a compressor for use in a vehicle.

In vehicle air conditioners, mechanically driven compressors are widely used. Such compressor includes a casing having therein a suction chamber and a discharge chamber and rotatably supporting a drive shaft. The drive shaft is rotated by a drive source such as an engine, and the piston of the compressor is reciprocated to compress refrigerant.

However, when such type of compressor is used in a vehicle equipped with an idling stop function that automatically stops the drive source while the vehicle is at a stop so as to meet the recent requirement of carbon dioxide emission regulations, no compression is performed by the compressor, resulting in reduced air conditioning performance. To solve this problem, a vehicle air conditioner including not only a mechanical compressor but also with an electric compressor is proposed in Japanese Unexamined Patent Application Publications No. 9-295510, No. 2003-341334 and No. 2004-237907. In the air conditioner, the electric compressor is operated while the drive source is stopped, which prevents reduction of air conditioning performance.

However, such use of the plural compressors makes it difficult to install the air conditioner in the vehicle. Specifically, in conventional vehicles, particularly in small vehicles that are intended to be equipped with a single compressor for air conditioning, the provision of an installation space for plural compressors is quite difficult.

The present invention is directed to providing a compressor that allows air conditioning while a drive source is at a stop and also easy installation in a vehicle.

### SUMMARY OF THE INVENTION

In accordance with an aspect of the present invention, a compressor for use in a vehicle includes a mechanical compression mechanism including a first casing and a drive shaft. The first casing has therein a first suction chamber and a first discharge chamber. The drive shaft is rotatably supported by the first casing and mechanically driven by a drive source for compression of refrigerant. The compressor further includes a linear electric compression mechanism including a second casing and a piston. The second, casing has therein a second suction chamber and a second discharge chamber. The piston is reciprocally movable in the second casing and driven by electromagnetic force for compression of refrigerant. The first casing is integrated with the second casing so as to allow at least one of fluid communication between the first suction chamber and the second suction chamber and between the first discharge chamber and the second discharge chamber.

Other aspects and advantages of the invention will become apparent from the following description, taken in conjunction with the accompanying drawings, illustrating by way of example the principles of the invention.

### BRIEF DESCRIPTION OF THE DRAWINGS

FIG. 1 is a longitudinal sectional view of a compressor according to a first embodiment of the present invention;

FIG. 2 is a schematic view of a vehicle air conditioner using the compressor of FIG. 1;

FIG. 3 is an enlarged sectional view of a linear electric compression mechanism of the compressor of FIG. 1;

FIG. 4 is an enlarged fragmentary sectional view of the linear compression mechanism of FIG. 3;

FIG. 5 is a schematic view of an arrangement of coils and permanent magnets of the linear electric compression mechanism of FIGS. 3 and 4;

FIG. 6 is a longitudinal sectional view of a compressor according to a second embodiment of the present invention; and

FIG. 7 is an enlarged fragmentary sectional view of a linear electric compression mechanism of the compressor of FIG. 6.

### DETAILED DESCRIPTION OF THE PREFERRED EMBODIMENTS

The following will describe the embodiments of the compressor according to the present invention with reference to the accompanying drawings. In the embodiments, the compressor is intended to be used in a vehicle air conditioner for a hybrid vehicle or electric vehicle equipped with an idling stop system.

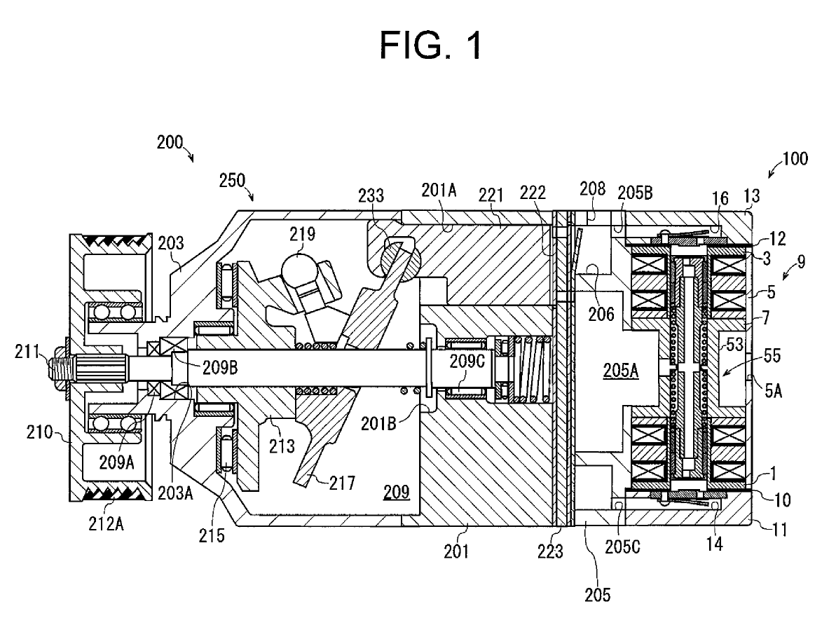

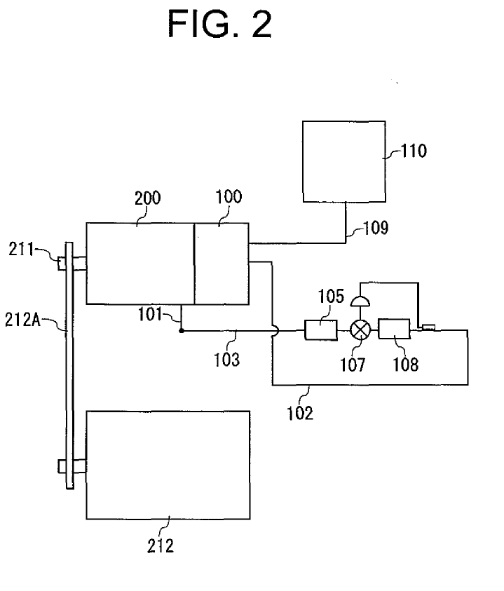

Referring to FIGS. 1 and 2, the compressor of the first embodiment includes a mechanical compression mechanism 200 and a linear electric compression mechanism 100. The mechanical compression mechanism 200 is of a swash plate type and driven by an engine 212 (drive source) to compress refrigerant. The linear electric compression mechanism 100 is driven by an electric power supply 110 to compress refrigerant.

As shown in FIG. 1, the mechanical compression mechanism 200 has a first cylinder block 201 formed with plural cylinder bores 201A (only one is shown) extending parallel to one another and arranged circularly around the axis of the first cylinder block 201 at regular intervals. The first cylinder block 201 is disposed between a front housing 203 and a rear housing 205 and fastened thereto. The first cylinder block 201 cooperates with the front housing 203 to form therebetween a crank chamber 209.

The rear housing 205 is formed with a shell 5 that is a component of the linear electric compression mechanism 100. The rear housing 205 has a first suction chamber 205A and an annular first discharge chamber 206 formed therein. The first suction chamber 205A is located in the center of the rear housing 205, and the first discharge chamber 206 is located radially outward of the first suction chamber 205A. The rear housing 205 is formed therethrough with an outlet port 208, a first discharge passage 205B and a second discharge passage 205C each communicating with the first discharge chamber 206.

The first suction chamber 205A is connected through an inlet port 5A to a pipe 102 (see FIG. 2). The first discharge chamber 206 is connected through the outlet port 208 to a pipe 101 (see FIG. 2). The rear housing 205 serves as the first housing of the present invention. The first cylinder block 201 cooperates with the front housing 203 and the rear housing 205 to form a first casing 250.

As shown in FIG. 1, the front housing 203 and the first cylinder block 201 have shaft holes 203A and 201B, respectively, by which a drive shaft 211 is rotatably supported through a shaft seal 209A and bearings 209B and 209C. The drive shaft 211 is connected to a pulley 210 engaged over a belt 212A that is driven by the engine 212 (see FIG. 2). The pulley 210 may be replaced with an electromagnetic clutch.

In the crank chamber 209, the drive shaft 211 is fixed to a lug plate 213 by press fitting, and a bearing 215 is provided between the lug plate 213 and the front housing 203. The drive shaft 211 is inserted in a swash plate 217. The lug plate 213 is connected to the swash plate 217 through a link mechanism 219 that allows the swash plate 217 to be inclined relative to the drive shaft 211.

Each cylinder bore 201A of the first cylinder block 201 receives a piston 221 reciprocally movable therein. A valve unit 223 is provided between the first cylinder block 210 and the rear housing 205. The piston 221 in each cylinder bore 201A cooperates with the valve unit 223 to form a compression chamber 222 therebetween. When the piston 221 is in the suction stroke, refrigerant is introduced from the first suction chamber 205A through the valve unit 223 into the compression chamber 222. The refrigerant is compressed in the compression chamber 222 when the piston 221 is in the compression stroke, and then discharged through the valve unit 223 into the first discharge chamber 206 when the piston 221 is in the discharge stroke.

Each piston 221 is connected to the swash plate 217 through a pair of shoes 233 by which oscillating motion of the swash plate 217 is converted into reciprocating motion of the piston 221.

Although not shown in the drawings, the crank chamber 209 and the first suction chamber 205A are connected through a bleed passage, and the crank chamber 209 and the first discharge chamber 206 are connected through a supply passage provided with a control valve for controlling the displacement of the mechanical compression mechanism 200.

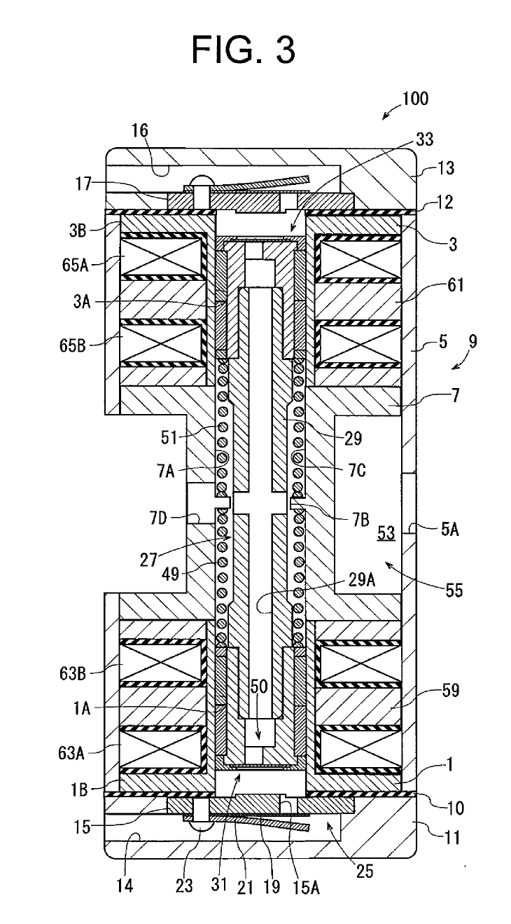

Referring to FIG. 3, the linear electric compression mechanism 100 includes second cylinder blocks 1, 3, the shell 5 and a center housing 7, which cooperate to form a second housing 9 of the linear electric compression mechanism 100. The second cylinder blocks 1, 3 have a first cylinder bore 1A and a second cylinder bore 3A formed therethrough, respectively. The first and second cylinder bores 1A, 3A are substantially concentric with each other and have substantially the same diameter. The shell 5 is formed therethrough with the inlet port 5A described above.

The second cylinder blocks 1, 3 have flanges 1B, 3B around the first and second cylinder bores 1A, 3A, respectively. The second cylinder blocks 1, 3 are accommodated in the shell 5 so that the flanges 1B, 3B are located at opposite ends of the shell 5. The center housing 7 is provided in the shell 5 between the second cylinder blocks 1, 3. The center housing 7 has a bore 7A (cylinder bore) which is substantially concentric with the first and second cylinder bores 1A, 3A and whose diameter is substantially the same as those of the first and second cylinder bores 1A, 3A.

A first and a second end plates 11, 13 are mounted to the opposite ends of the shell 5 through a first and a second gaskets 10, 12, respectively. The first and second end plates 11, 13 cooperate with the second housing 9 to form the second casing of the present invention. The first and second end plates 11, 13 have recesses formed therein. A first valve plate 15 is held between the first gasket 10 and the first end plate 11, and a second valve plate 17 is held between the second gasket 12 and the second end plate 13. The first and second end plates 11, 13 cooperate with the first and second valve plates 15, 17 to form therebetween second discharge chambers 14, 16, respectively. As shown in FIG. 1, the second discharge chamber 14 communicates with the first discharge chamber 206 in facing relation to each other through the second discharge passage 205C, and the second discharge chamber 16 communicates with the first discharge passage 206 in facing relation to each other through the first discharge passage 205B.

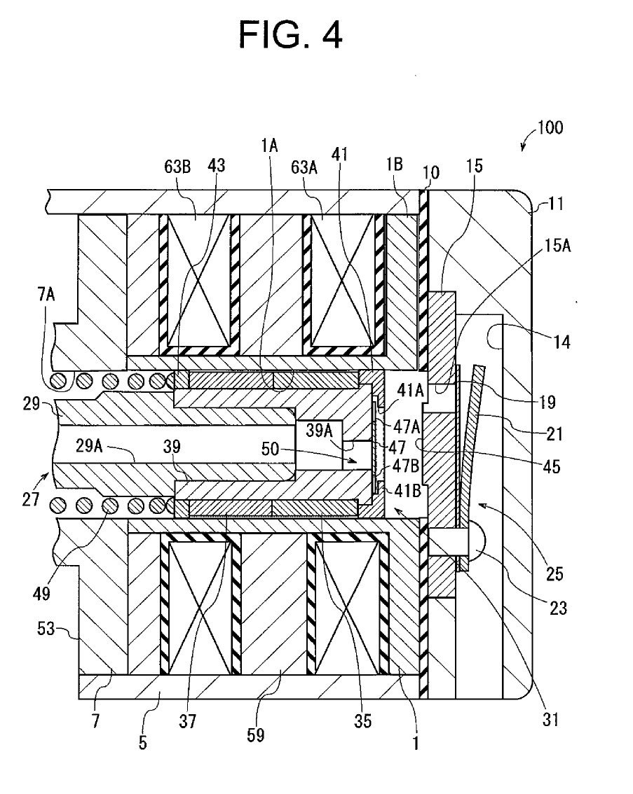

Referring to FIGS. 3 and 4, the first valve plate 15 is formed therethrough with a discharge port 15A. A reed type discharge valve 19 for the discharge port 15A and a retainer 21 for restricting the opening of the discharge valve 19 are fixed by a rivet 23 to the first valve plate 15 on the side of the second discharge chamber 14. The first valve plate 15, the discharge valve 19, the retainer 21 and the rivet 23 cooperate to form a first valve unit 25. A valve unit for the second valve plate 17 is formed similarly.

As shown in FIG. 3, the first and second cylinder bores 1A, 3A and the bore 7A receive a piston 27 reciprocally movable therein. The piston 27 includes a piston rod 29, a first piston head 31 provided at one end of the piston rod 29 so as to slide in the first cylinder bore 1A, and a second piston head 33 provided at the other end of the piston rod 29 so as to slide in the second cylinder bore 3A.

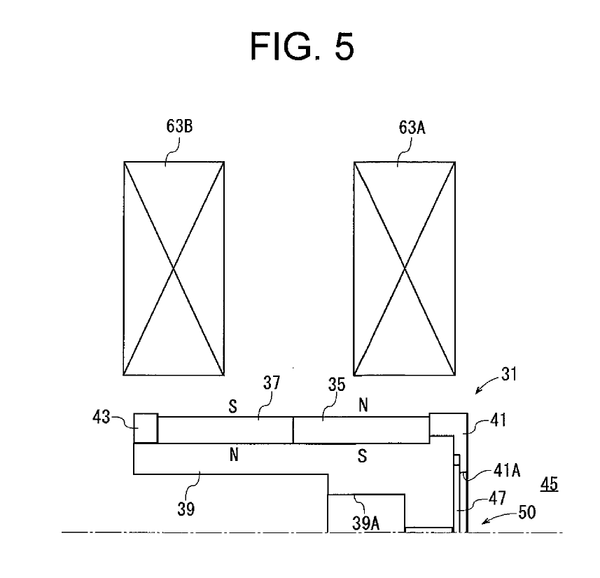

As shown in FIGS. 4 and 5, the first piston head 31 includes a head 39, a first spacer 41, and a second spacer 43. Permanent magnets 35, 37 are mounted on the outer surface of the head 39. The first and second spacers 41, 43 are provided on the head 39 so as to space the outer surfaces of the permanent magnets 35, 37 from the inner surface of the first cylinder bore 1A.

As shown in FIG. 5, the permanent magnets 35, 37 are ring shaped and provided by a rare-earth magnet. The permanent magnet 35 has the north pole and the south poles on the outer peripheral side and inner peripheral side of the ring-shaped magnet, respectively, while the permanent magnet 37 has the south pole and the north poles on the outer peripheral side and inner peripheral side of the ring-shaped magnet, respectively. The polar character of the permanent magnets 35, 37 may be reversed.

In installing the permanent magnets 37, 35, firstly the second spacer 43 is press fit on the head 39, the permanent magnets 37, 35 are press fit on the outer surface of the head 39, and then the first spacer 41 is press fit on the outer surface of the head 39, as shown in FIG. 4. The permanent magnets 35, 37 are thus held securely on the outer surface of the head 39 between the first and second spacers 41, 43. The piston head 31 cooperates with the first valve unit 25 to form a compression chamber 45 therebetween.

The head 39 is formed therethrough with a suction port 39A. The first spacer 41 is formed therethrough with a valve hole 41A that is communicable with the suction port 39A and receives therein a float type suction valve 47. The valve hole 41A has a stop 41B on the side of the compression chamber 45. The suction valve 47 has on the outer periphery thereof plural engaging portions 47A that are brought into contact with the stop 41B when the suction port 39A is opened. A cutout 47B is formed between any two adjacent engaging portions 47A.

As shown in FIG. 3, the first and second piston heads 31, 33 are press fit on the opposite ends of the piston rod 29. The piston rod 29 has a diameter that is smaller than those of the first and second piston heads 31, 33. The piston rod 29 is formed therethrough with a suction passage 29A. The suction passage 29A includes also radially extending passages in the center of the piston rod 29 so as to open at the outer peripheral surface of the piston rod 29. As shown in FIG. 4, the suction passage 29A communicates with the suction port 39A of the first piston head 31. The suction passage 29A, the suction port 39A, the suction valve 47 and the first spacer 41 cooperate to form a suction valve mechanism 50. A suction valve mechanism for the second piston head 33 is formed similarly.

As shown in FIG. 3, the center housing 7 has a spring seat 7B in the bore 7A. The spring seat 7B projects radially inward from the inner surface of the bore 7A at the center between the opposite end surfaces of the second cylinder blocks 1, 3. The space between the inner surface of the bore 7A and the outer surface of the piston rod 29 forms a spring space 7C where a first coil spring 41 and a second coil spring 51 are accommodated.

The first coil spring 49 is preloaded with one end thereof in contact with the spring seat 7B and the other end thereof in contact with the second spacer 43 of the first piston head 31. The second coil spring 51 is preloaded with one end thereof in contact with the spring seat 7B and the other end thereof in contact with the second spacer of the second piston head 33.

The center housing 7 and the shell 5 form an intermediate chamber 53 therebetween. The center housing 7 is formed therethrough with a communication hole 7D through which the intermediate chamber 53 communicates with the spring space 7C. The intermediate chamber 53 and the spring space 7C cooperate to form a second suction chamber 55 that communicates with the first suction chamber 205A (see FIG. 1) in facing relation to each other through the communication hole 7D. Although not shown in the drawings, terminals connected to coils 63A, 63B, 65A, 65B, which will be described later, are mounted in the second suction chamber 55.

The coils 63A, 63B are provided between the shell 5 and the second cylinder block 1. The coils 63A, 63B are held by a first holder 59 so as to surround the first piston head 31. Similarly, the coils 65A, 65B are provided between the shell 5 and the second cylinder block 3. The coils 65A, 65B are held by a second holder 61 so as to surround the second piston head 33. The second cylinder blocks 1, 3 and the first and second holders 59, 61 are made of a magnetic material. The second cylinder blocks 1, 3 may be made of a nonmagnetic material.

As shown in FIG. 2, the linear electric compression mechanism 100 is connected through the pipes 101, 103 to a condenser 105. The condenser 105 is connected through an expansion valve 107 and an evaporator 108 to a pipe 102 that is connected to the inlet port 5A (see FIG. 3). The terminals in the intermediate chamber 53 are connected to the electric power supply 110 through a lead wire 109. The electric power supply 110 is electrically controlled by a controller (not shown).

In the above-described compressor, when the engine 212 is operating and vehicle is running, the drive shaft 211 of the mechanical compression mechanism 200 is rotated, and the lug plate 213 and the swash plate 217 are rotated integrally with the drive shaft 211. The pistons 221 are reciprocated in the respective cylinder bores 201A at a stroke depending on the inclination angle of the swash plate 217, and refrigerant in the first suction chamber 205A is introduced into the compression chambers 222 and compressed therein. After being discharged into the first discharge chamber 206, the refrigerant is delivered out of the compressor and then through the pipes 101, 103 to the condenser 105, the expansion valve 107 and the evaporator 108. Thus air conditioning of the vehicle compartment by the mechanical compression mechanism 200 is accomplished.

When the vehicle is stopped at a traffic light, the engine speed is reduced to an idling speed and then the engine 212 is stopped. In this case, the electric power supply 110 periodically supplies electric power to the coils 63A, 63B, 65A, 65B of the linear electric compression mechanism 100 thereby to generate periodically variable electromagnetic force around the coils 63A, 63B, 65A, 65B. Referring to FIG. 5, when the coil 63A attracts the permanent magnet 35 of the first piston head 31, magnetic repulsion is produced between the coil 63B and the permanent magnet 37 of the first piston head 31. On the other hand, when magnetic repulsion is produced between the coil 63A and the permanent magnet 35 of the first piston head 31, the coil 63B attracts the permanent magnet 37 of the first piston head 31. Thus, the linear electric compression mechanism 100 can provide a large thrust force to reciprocate the piston 27.

Thus, the permanent magnets 35, 37 of the piston 27 are attracted and repelled by electromagnetic force generated by the coils 63A, 63B, 65A, 65B, so that the piston 27 is reciprocated in the first and second cylinder bores 1A, 3A. In this case, the resonance of the first and second coil springs 49, 51 oscillating at the natural frequency serves to reciprocate the piston 27.

Strokes of suction, compression and discharge of refrigerant are accomplished by the reciprocating movement of the piston 27. As shown in FIG. 4, when the first piston head 31 is in the suction stroke, the pressure in the compression chamber 45 is reduced and, accordingly, the suction valve 47 is moved within the valve hole 41A so as to open the suction port 39A. Refrigerant in the second suction chamber 55 (see FIG. 3) is introduced from the suction port 39A into the compression chamber 45 through the clearances between the cutouts 47B of the suction valve 47 and the stop 41B. The discharge port 15A is closed by the discharge valve 19.

When the first piston head 31 begins the compression stroke, the suction valve 47 is moved within the valve hole 41A so as to close the suction port 39A, and the pressure in the compression chamber 45 is increased thereby to open the discharge valve 19. That is, the first piston head 31 begins the discharge stroke and the compressed refrigerant is discharged through the discharge port 15A into the second discharge chamber 14. Though the temperature of refrigerant in the second discharge chamber 14 is high, the first gasket 10 provided between the first end plate 11 and the second cylinder block 1 prevents the piston 27 from being exposed directly to the second discharge chamber 14. Thus, the piston 27 is hardly affected by the heat of the refrigerant in the second discharge chamber 14. The same is true of the second piston head 33 side

Referring to FIG. 2, refrigerant flowing out from the evaporator 108 into the pipe 102 is introduced through the second suction chamber 55 into the compression chamber 45 of the linear electric compression mechanism 100. Refrigerant is compressed in the compression chamber 45, discharged into the second discharge chambers 14, 16, and then delivered through the pipes 101, 103 to the condenser 105. Thus air conditioning of the vehicle compartment by the linear electric compression mechanism 100 is accomplished.

The linear electric compression mechanism 100 in which the compression chambers 45 are formed at the opposite ends of the piston 27 can compress refrigerant twice by a single reciprocating movement of the piston 27, which increases the efficiency of compression of refrigerant per unit time while reducing the size of the compressor. Thus, the compressor according to the present embodiment allows easy installation in a vehicle while achieving high air conditioning performance.

In addition, the rear housing 205 is integrated with the shell 5 so as to allow fluid communication between the first suction chamber 205A and the second suction chamber 55 and between the first discharge chamber 206 and the second discharge chambers 14, 16. In this case, the interior space of the compressor is shared by the mechanical compression mechanism 200 and the linear electric compression mechanism 100, which allows reduction in the size of the compressor and easy installation of the compressor in a vehicle, as compared to the case where the interior space of the compressor is not shared by the compression mechanisms 200 and 100.

Thus, the compressor according the present embodiment allows air conditioning while a drive source is at a stop and also easy installation in a vehicle.

The integration of the rear housing 205 with the shell 5 allows easier management of compressor parts and components and results in reduced manufacturing cost.

Particularly in the present embodiment, the inlet port 5A through which the first and second suction chambers 205A, 55 communicate with the outside, that is, the inlet port 5A for introducing refrigerant into the compressor is shared by the mechanical compression mechanism 200 and the linear electric compression mechanism 100. Similarly, the outlet port 208 through which the first and second discharge chambers 206, 14, 16 communicate with the outside, that is, the outlet port 208 for discharging refrigerant out of the compressor is also shared by the mechanisms 100, 200. In such a case, since the inlet port 5A communicates with the first and second suction chambers 205A, 55 and the outlet port 208 communicates with the first and second discharge chambers 206, 14, 16, refrigerant is introduced though the common inlet port 5A into the first and second suction chambers 205A, 55 and discharged from the first and second discharge chambers 206, 14, 16 through the common outlet port 208 out of the compressor. The connection of the pipes 101, 102 to the compressor can be simplified, thereby allowing easier installation of the compressor in a vehicle.

In the present embodiment, the rear housing 205 has the first suction chamber 205A in the center thereof, that is, in a position axially extended from the end of the drive shaft 211, and the first discharge chamber 206 in a position radially outward of the first suction chamber 205A. The second discharge chambers 14, 16 are located at the opposite ends of the second housing 9. The rear housing 205 is integrated with the shell 5 so that the axis of the drive shaft 211 is perpendicular to the axis of the piston rod 29. In such a case, the components of the linear electric compression mechanism 100 are aligned in the radial direction of the mechanical compression mechanism 200, so that the mechanisms 100 and 200 are integrated neatly.

In the linear electric compression mechanism 100, the intermediate chamber 53 is formed between the shell 5 and the second cylinder blocks 1, 3. The first valve units 25 cooperate with the first and second end plates 11, 13 to form therebetween the second discharge chambers 14, 16, respectively, and the suction valve mechanisms 50 are provided in the respective first and second piston heads 31, 33. The spring space 7C, which is a part of the second suction chamber 55, and the suction passage 29A are formed in the piston 27. In such a case, the piston 27 can be made lighter, and the linear electric compression mechanism 100 can be made smaller while achieving high efficiency of compression of refrigerant.

The diameter of the piston rod 29 is smaller than that of the first and second piston heads 31, 33. The center housing 7 has the spring seat 7B, and the first and second coil springs 49, 51 are provided between the spring seat 7B and the respective piston heads 31, 33. This allows the linear electric compression mechanism 100 to dispense with a means such as a spring in the compression chamber 45, thereby increasing the volume of the compression chamber 45. Further, the diameter of the first and second coil springs 49, 51 does not become larger than that of the first and second piston heads 31, 33 and, therefore, the linear electric compression mechanism 100 can be made smaller while achieving high efficiency of compression of refrigerant.

The linear electric compression mechanism 100, in which the second housing 9 is formed by the second cylinder blocks 1, 3 and the shell 5, allows easy installation of the coils 63A, 63B, 65A, 65B between the second cylinder blocks 1, 3 and the shell 5, which facilitates assembling of the linear electric compression mechanism 100.

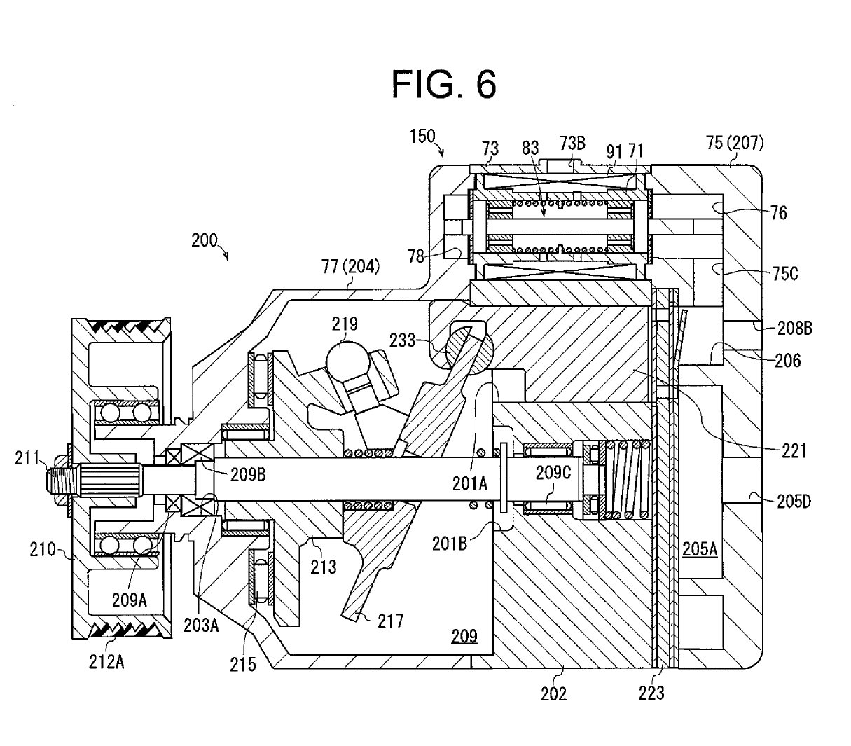

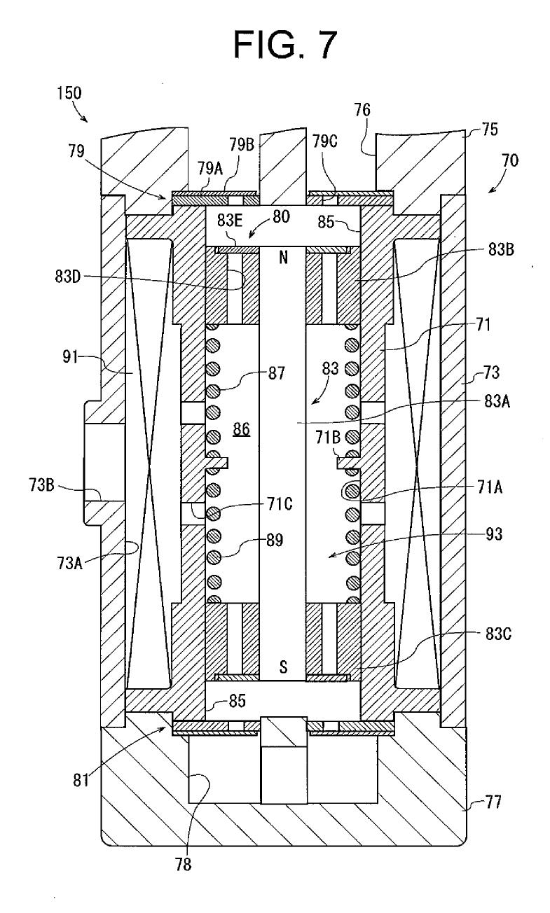

FIGS. 6 and 7 show the second embodiment of the present invention. In the drawings, same reference numerals are used for the common elements or components in the first and second embodiments, and the description of such elements or components for the second embodiment will be omitted.

As shown in FIG. 7, the linear electric compression mechanism 150 includes a second cylinder block 71 and a shell 73 which cooperate to form a second housing 70 of the linear electric compression mechanism 150. The second cylinder block 71 has a cylinder bore 71A formed therethrough.

The shell 73 is located radially outward of the second cylinder block 71. A first and a second end plates 75, 77 are mounted to the opposite ends of the shell 73 and the second cylinder block 71. The first and second end plates 75, 77 cooperate with the second housing 70 to form the second casing of the present invention. The first and second end plates 75, 77 have recesses formed therein. A first valve unit 79 is held between the second cylinder block 71 and the first end plate 75, and a second valve unit 81 is held between the second cylinder block 71 and the second end plate 77. The first and second end plates 75, 77 cooperate with the first and second valve units 79, 81 to form therebetween second discharge chambers 76, 78, respectively. The second discharge chambers 76, 78 are connected through a discharge passage (not shown).

The first valve unit 79 includes a first valve plate 79A and a reed type discharge valve 79B. The first valve plate 79A is formed therethrough with a discharge port 79C that is opened and closed by the discharge valve 79B. The structure of the second valve unit 81 is similar to that of the first valve unit 79.

The cylinder bore 71A receives a piston 83 reciprocally movable therein. The piston 83 includes a piston rod 83A, a first piston head 83B provided at one end of the piston rod 83A so as to slide in the cylinder bore 71A, and a second piston head 83C provided at the other end of the piston rod 83A so as to slide in the cylinder bore 71A.

The piston rod 83A has a diameter that is smaller than those of the first and second piston heads 83B, 83C. The piston rod 83A is a permanent magnet provided by a rare-earth magnet and having the north pole on one end and the south pole on the other end. The piston rod 83A may have the south pole on one end and the north pole on the other end. The first piston head 83B cooperates with the first valve unit 79 to form a compression chamber 85 therebetween, and similarly the second piston head 83C cooperates with the second valve unit 81 to form a compression chamber 85 therebetween

The first piston head 83B is formed therethrough with plural suction ports 83D, and a reed type suction valve 83E for the suction ports 83D is mounted to the first piston head 83B on the side of the compression chamber 85. The suction ports 83D and the suction valve 83E cooperate to form a suction valve mechanism 80. A suction valve mechanism of the second piston head 83C is formed similarly.

The second cylinder block 71 has a spring seat 71B in the cylinder bore. The spring seat 71B projects radially inward from the inner surface of the cylinder bore 71A at the center between the opposite end surfaces. The space between the inner surface of the cylinder bore 71A and the outer surface of the piston rod 83A forms an intermediate chamber 86 where a first and a second coil springs 87, 89 are accommodated.

The first coil spring 87 is preloaded with one end thereof in contact with the spring seat 71B and the other end thereof in contact with the first piston head 83B. The second coil spring 89 is preloaded with one end thereof in contact with the spring seat 71B and the other end thereof in contact with the second piston head 83C.

The space between the second cylinder block 71 and the shell 73 forms a suction passage 73A in which a coil 91 is provided. Although not shown in the drawings, the coil 91 is connected through the terminal and the lead wire to the electric power supply. The second cylinder block 71 is formed therethrough with plural suction ports 71C through which the intermediate chamber 86 in the cylinder bore 71A communicates with the suction passage 73A. The intermediate chamber 86 and the suction passage 73A cooperate to form a second suction chamber 93. The shell 73 is formed therethrough with an inlet port 73B communicating with the suction passage 73A.

As shown in FIG. 6, the shell 73 of the linear electric compression mechanism 150 is formed by part of the first cylinder block 202 of the mechanical compression mechanism 200. The second end plate 77 of the linear electric compression mechanism 150 is formed by part of the front housing 204 of the mechanical compression mechanism 200, and the first end plate 75 of the linear electric compression mechanism 150 is formed by part of the rear housing 207 of the mechanical compression mechanism 200. The second housing 70 is located radially outward of the first cylinder block 202 (cylinder block), the second end plate 77 is integrated with the front housing 204 (first casing), and the first end plate 75 is integrated with the rear housing 207 (first housing).

The inlet port 205D of the mechanical compression mechanism 200 and the inlet port 73B of the linear electric compression mechanism 150 are connected to the evaporator 108 through a pipe (not shown). The second discharge chamber 76 of the linear electric compression mechanism 150 is connected through the discharge passage 75C to the first discharge chamber 206 of the mechanical compression mechanism 200. The outlet port 208B is connected to the condenser 105 through a pipe (not shown). In the second embodiment, the first cylinder block 202 is integrated with the shell 73 so as to allow fluid communication between the first discharge chamber 206 and the second discharge chambers 76, 78. The outlet port 208B communicates with the first and second discharge chambers 206, 76, 78 so that the outlet port 208B is shared by the mechanical compression mechanism 200 and the linear electric compression mechanism 150.

According to the second embodiment, the first cylinder block 202 is integrated with the shell 73 so that the axis of the drive shaft 211 is parallel to the axis of the piston rod 83A. In such a case, the components of the linear electric compression mechanism 150 are aligned in the axial direction of the mechanical compression mechanism 200, so that the mechanisms 150 and 200 are integrated neatly. In addition, the integration of components such as the first cylinder block 202, the shell 73, the front and rear housings 204, 207, and the first and second end plates 75, 77 allows easier management of compressor parts and components and results in reduced manufacturing cost. The second embodiment also offers the advantages similar to those of the first embodiment.

The above embodiments may be modified in various ways as exemplified below.

The mechanical compression mechanism 200 may be of a vane type or a scroll type. The drive source includes not only a general internal combustion engine but also a hybrid engine or an electric motor.

The present invention is applicable not only to a hybrid vehicle or an electric vehicle with electric motor but also an engine powered vehicle.

What is claimed is:

1. A compressor for use in a vehicle, comprising:
a mechanical compression mechanism including a first casing and a drive shaft, the first casing having therein a first suction chamber and a first discharge chamber, the drive shaft being rotatably supported by the first casing and mechanically driven by a drive source for compression of refrigerant; and
a linear electric compression mechanism including a second casing and a piston, the second casing having therein a second suction chamber and a second discharge chamber, the piston being reciprocally movable in the second casing and driven by electromagnetic force for compression of refrigerant,
wherein the first casing is integrated with the second casing so as to allow at least one of fluid communication between the first suction chamber and the second suction chamber and between the first discharge chamber and the second discharge chamber.

2. The compressor according to claim 1, further comprising an outlet port for discharging refrigerant out of the compressor, wherein the outlet port communicates with the first discharge chamber and the second discharge chamber so that the outlet port is shared by the mechanical compression mechanism and the linear electric compression mechanism.

3. The compressor according to claim 2, further comprising an inlet port for introducing refrigerant into the compressor, wherein the inlet port communicates with the first suction chamber and the second suction chamber so that the inlet port is shared by the mechanical compression mechanism and the linear electric compression mechanism.

4. The compressor according to claim 3, wherein the first casing includes a first housing in which the first suction chamber is located in a position axially extended from the end of the drive shaft and the first discharge chamber is located radially outward of the first suction chamber,
wherein the second casing is formed by a second housing and a pair of end plates, the second housing is formed therethrough with a cylinder bore in which the piston is reciprocally movable, the end plates are mounted to opposite ends of the second housing, valve units are held between the cylinder bore and the respective end plates, the piston in the cylinder bore cooperates with the respective valve units to form compression chambers therebetween, a permanent magnet is provided in the piston, a coil is provided in the second housing so as to generate electromagnetic force acting on the permanent magnet, the piston includes a piston rod and a pair of piston heads, the piston heads are provided at opposite ends of the piston rod, the second suction chamber is located between the piston heads, the second discharge chamber is located at each end of the second housing,
wherein the first housing is integrated with the second housing so that the axis of the drive shaft is perpendicular to the axis of the piston rod.

5. The compressor according to claim 4, wherein the second housing includes a shell where the coil is received, the shell being integrated with the first housing.

6. The compressor according to claim 4, wherein the second discharge chamber is formed between the valve unit and the end plate and communicates with the first discharge chamber in facing relation to each other through a passage, the second suction chamber communicates with the first suction chamber in facing relation to each other through a communication hole.

7. The compressor according to claim 2, wherein the first casing includes a cylinder block rotatably supporting the drive shaft and a first housing in which the first suction chamber is located in a position axially extended from the end of the drive shaft and the first discharge chamber is located radially outward of the first suction chamber,
wherein the second casing is formed by a second housing and a pair of end plates, the second housing is formed therethrough with a cylinder bore in which the piston is reciprocally movable, the end plates are mounted to opposite ends of the second housing, valve units are held between the cylinder bore and the respective end plates, the piston in the cylinder bore cooperates with the respective valve units to form compression chambers therebetween, a permanent magnet is provided in the piston, a coil is provided in the second housing so as to generate electromagnetic force acting on the permanent magnet, the piston includes a piston rod and a pair of piston heads, the piston heads are provided at opposite ends of the piston rod, the second suction chamber is located between the piston heads, the second discharge chamber is located at each end of the second housing,
wherein the cylinder block is integrated with the second housing so that the axis of the drive shaft is parallel to the axis of the piston rod.

8. The compressor according to claim 7, wherein the second housing is located radially outward of the cylinder block, one of the end plates is integrated with the first casing, and the other end plate is integrated with the first housing.

9. The compressor according to claim 4, wherein the diameter of the piston rod is smaller than that of the piston heads, the second housing has a spring seat in the cylinder bore, and coil springs are provided between the spring seat and the respective piston heads in the cylinder bore.

10. The compressor according to claim 9, wherein part of the second suction chamber is formed by a space where the coil springs are accommodated.
